(19) United States
(12) Patent Application Publication
(10) Pub. No.: US 2011/0119276 A1
(43) Pub. Date: May 19, 2011

(54) SUBMISSION CAPTURE, AUTO-RESPONSE AND PROCESSING SYSTEM

(75) Inventors: William F. Borghetti, Salt Lake City, UT (US); Tim Dewayne Mills, Littleton, CO (US)

(73) Assignee: SENDSIDE NETWORKS, INC, Salt Lake City, UT (US)

(21) Appl. No.: 12/948,653

(22) Filed: Nov. 17, 2010

Related U.S. Application Data
(60) Provisional application No. 61/261,748, filed on Nov. 17, 2009.

(51) Int. Cl. G06F 17/30; G06F 15/16

(52) U.S. Cl. 707/748; 709/206; 707/E17.084

(57) ABSTRACT

A method of capturing end-user data includes receiving end-user data. The method also includes validating the end-user data. The method also includes assigning a score to at least some of the end-user data based on the validation. The method also includes performing at least one of a plurality of different actions in relation to the end-user data based on the assigned score.

### CROSS-REFERENCE TO RELATED APPLICATIONS

This application claims the benefit of U.S. Provisional Application No. 61/261,748 filed on 17 Nov. 2009, the disclosure of which is incorporated herein, in its entirety, by this reference.

### BACKGROUND

1. Field of the Invention

Some embodiments generally relate to the electronic capture, processing and management of end-user data.

2. Related Technology

Various technologies exist for managing the sales leads of a business. None of these technologies offer a comprehensive approach for responding to leads, filtering the leads, assigning them, scoring them and, ultimately, integrating them into a Customer Resource Management or CRM system. Electronic forms can be configured such that the contents, upon submission, are inputted automatically into a CRM system. Examples of CRM systems include Salesforce®, Siebel® (Oracle®) and Microsoft Dynamics®.

The end-user data is typically stored in the CRM system without regard to its quality, e.g., the completeness of the end-user data, the type of end-user data submitted, whether the end-user data includes invalid contact information, segmentation data, i.e., how close the end user is to making a purchase, or the like. Sales representatives or other individuals have to sift through the end-user data from all of the different end users to eliminate invalid end-user data and/or to individually follow up with the end users. Thus, some of the sales representative's time is wasted reviewing or following up on non-existent or low quality sales leads.

The present application appreciates that there is typically a strong need to be able to respond to leads more timely. In this regard, sales representatives typically follow up on new sales leads (e.g., end-user data) in sequential order based on when the new sales leads are stored in the CRM system. Thus, it takes the sales representatives the same amount of time to follow up on a high quality sales lead as a low quality sales lead. Additionally, many organizations call EVERY lead, which is time and cost intensive and doesn't necessarily produce better results. However, research has shown that the likelihood of closing a deal on a sales lead falls off exponentially as a function of the time it takes to respond to the sales lead. For example, a sales representative is much more likely to close a deal if they respond to an inquiry from a potential sales lead within five minutes than if they respond to the inquiry within 30 minutes. Depending on the number of new sales leads in the CRM system, the sales representatives may take so long to follow up on the high quality sales lead that the business opportunity with the corresponding end user is lost. Similarly, if new sales leads are not managed in a CRM system at all, but are instead sent directly to sales representatives that may not be currently on their computer or phone or who may be on vacation, it may take so long to follow up on high quality sales leads that business opportunities are lost.

Accordingly, the inability of conventional systems to determine the quality of incoming end-user data significantly impairs the efficiency of the sales representatives in closing business deals with end users.

Further, a sales representative may follow up with an end user by sending electronic materials to an email address of the end user. To the extent the sales representative sends the end user electronic materials, the electronic materials are included in an email message that cannot be changed by the sales representative after the email message has been sent. Further, the sales representative has no way of knowing whether and to what extent the end user has reviewed the content of the email message for subsequent follow up with the end user.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF SOME EXAMPLE EMBODIMENTS

In general, some example embodiments relate to the electronic capture, processing and management of end-user data.

In an embodiment, a method of capturing end-user data includes receiving end-user data. The method also includes validating the end-user data. The method also includes assigning a score to at least some of the end-user data based on the validation. The method also includes performing at least one of a plurality of different actions in relation to the end-user data based on the assigned score.

In an embodiment, a non-transitory computer-readable medium includes instructions that are executable by a computer to perform operations including receiving end-user data via an online web form. The operations also include validating the end-user data. The operations also include assigning a score to at least some of the end-user data based on the validation. The operations also include performing at least one of a plurality of different actions in relation to the end-user data based on the assigned score.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

These and other aspects of example embodiments will become more fully apparent from the following description and appended claims.

### BRIEF DESCRIPTION OF THE DRAWINGS

To further clarify various aspects of some embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example network environment including a submission capture, auto-response and processing system according to some embodiments;

FIGS. 2A-2B illustrate aspects of the submission capture, auto-response and processing system of FIG. 1 according to some embodiments;

FIG. 3 illustrates an example sales cycle implemented, at least in part, by the submission capture, auto-response and processing system of FIG. 1 according to some embodiments;

FIG. 4 depicts a conceptual diagram of an example electronic information package that can be generated and/or sent in response to one or more trigger events identified by the submission capture, auto-response and processing system of FIG. 1 according to some embodiments; and

FIG. 5 depicts a graphical representation of an example electronic information package according to some embodiments.

### DETAILED DESCRIPTION

Some embodiments described herein are directed to a submission capture, auto-response and processing (“SCARP”) system for processing incoming end-user data submitted by an end-user through a web form. The SCARP system manages the incoming end-user data, which may include sales leads, human resources (“HR”) forms and/or other end-user data. The SCARP system flexibly adapts to changes in sales process, organization, and/or product/service offering.

In some examples, the SCARP system receives incoming end-user data, validates it, and determines one or more actions to take with respect to the end-user data. Actions may include deleting the end-user data, creating an end-user record with the end-user data, qualifying the end-user data, prioritizing the end-user data, notifying one or more administrators about the end-user data, assigning the end-user data to a particular representative for follow-up and automatically generating and/or forwarding content, such as a request for an electronic signature, an email, an automated telephone call, or an electronic information package, to an end-user.

Some embodiments described herein alternately or additionally include methods and systems for generating and/or sending electronic packages to an end-user. Generally, electronic packages include multiple types of network-accessible content sections arranged in tabulated pages (tabulations can include related and unrelated content). Layout features of electronic packages also include, among other things, in-package rendering of attachments, sidebar display of content, displaying content sections as modals on a page in different locations and/or sizes.

### I. Example Network Environment

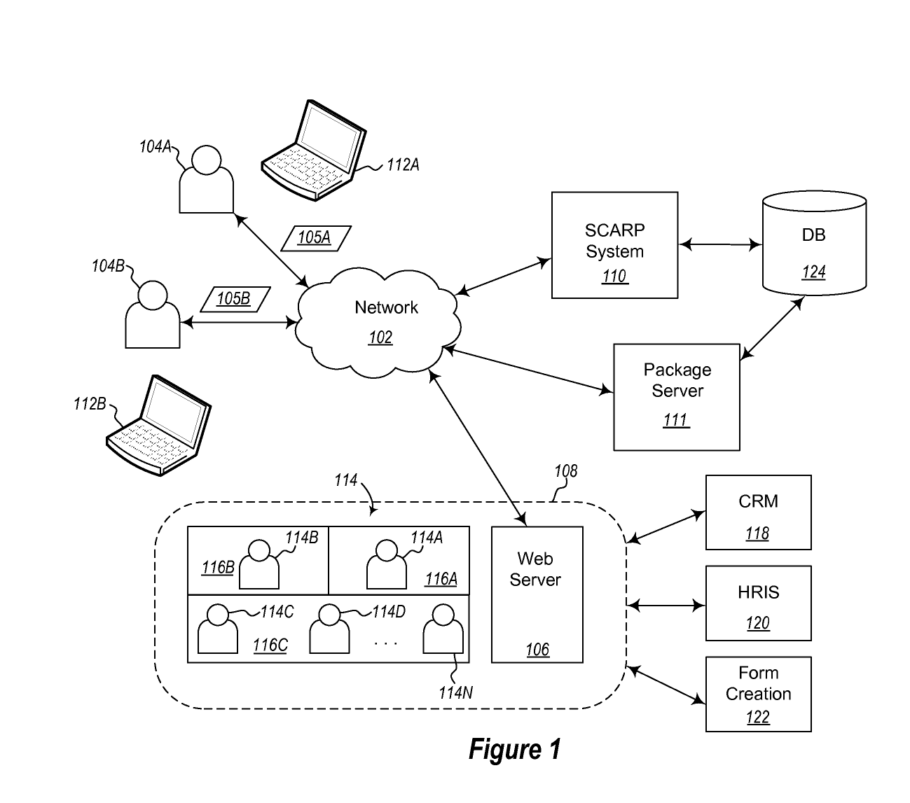

With reference now to FIG. 1, an example network environment 100 is illustrated in which some embodiments can be practiced. The example operating environment includes a network 102 over which one or more end-users 104A, 104B submit end-user data 105A, 105B via one or more web forms hosted by a web server 106 associated with an entity, represented by 108 in FIG. 1. The end-user data is provided over the network 102 to SCARP system 110 which attempts to validate the end-user data 105A, 105B and performs one or more actions in response to the end-user data. The example network environment further includes a package server 111.

The network 102 is illustrated in simplified form and includes, for example, the Internet, comprising a global internetwork formed by logical and physical connections between multiple wide area networks and/or local area networks. Alternately or additionally, the network 102 includes a cellular RF network and/or one or more wired and/or wireless networks such as, but not limited to, 802.xx networks, Bluetooth access points, wireless access points, IP-based networks, or the like. The network 102 also includes servers that enable one type of network to interface with another type of network.

The end-users 104A, 104B communicate over the network 102 using client devices 112A, 112B, which may include, for instance, a smartphone, laptop computer, desktop computer, or other suitable device.

The entity 108 may be a business, organization, or other entity and may have one or more employees or other users 114 associated with the entity 108, the employees or other users 114 being assigned to at least one of a plurality of departments 116A, 116B, 116C within the entity 108. In the example of FIG. 1, the entity 108 is a business with a marketing department 116A, a human resources (“HR”) department 116B and a sales department 116C, the employees 114 including a marketing director 114A, an HR director 114B, a sales manager 114C, and sales representatives 114D-114N.

The entity 108 and/or the employees 114 have access to one or more systems, such as a customer resource management or customer relationship management (“CRM”) system 118, a human resource information system (“HRIS”) 120, and/or a form creation system 122. For instance, the form creation system 122 may be accessible to the marketing director 114A to create web forms for receiving end-user data 105A, 105B from end users 104A, 104B. The HRIS 120 may store HR information that is accessible by the HR director 114B. The CRM system 118 may store marketing leads and/or sales leads that are accessible to one or more of the marketing director 114A, sales manager 114C and sales representatives 114D-114N. Alternately or additionally, the entity 108 may have access to one or more other databases or systems for storing information.

The web server 106 hosts a website associated with the entity 108, which website includes one or more webforms and/or content that can be accessed by end-users 104A, 104B. The content in some embodiments includes one or more of details regarding the entity 108 or its general line of business or purpose, product/service descriptions, surveys, job openings, white papers, or other content. Optionally, access by the end users 104A, 104B to some of the content is contingent upon first entering end-user data 105A, 105B into a web form.

For example, the web server 106 can host a web form that an end user 104A is required to fill out with end-user data 105A before being able to access a white paper or product/service descriptions. In this example, the web form may request end-user data 105A including one or more of a name, address, email address, phone number, or other information from the end user 104A. After the end user 104A has submitted some or all of the requested information, it is submitted as end-user data 105A and the web server 106 grants the end user 104A access to the white paper or product/service descriptions.

In other examples, end users 104A, 104B submit end-user data 105A, 105B whether or not access to content is contingent upon the end user 104A, 104B submitting the end-user data 105A, 105B. For instance, the website hosted by web server 106 may include job openings and one or more web forms for applying for the job openings in some embodiments. After viewing the job openings, the end-user 104A, 104B accesses a corresponding web form to apply for the job, the web form requesting end-user data 105A, 105B that may include one or more of a name, address, email address, phone number, résumé, work experience, or other information from the end user 104A, 104B.

As another example, the website hosted by the web server 106 may include one or more surveys administered through a web form that end users 104A, 104B decide to take for any of a variety of reasons. In this example, the web form requests end-user data 105A, 105B that may include one or more of survey responses and demographic information such as age, gender, income level, education level and/or marital status from the end users 104A, 104B.

As yet another example, the website hosted by web server 106 may include a “contact us” or analogous web page through which end-users 104A, 104B submit requests to the entity 108 for additional information. In this example, the web page includes or links to a web form that requests end-user data 105A, 105B from the end users 104A, 104B.

In the above-described examples, various types of information have been identified that may be included in end-user data 105A, 105B. However, end-user data 105A, 105B is not limited to the specific types of information explicitly identified herein and more generally includes any information submitted by an end user 104A, 104B through a web form.

In addition, web forms hosted on web servers 106 according to some embodiments include one or more optional information fields requesting information that end-users 104A, 104B can submit, but are not required to submit, to complete the web form. Alternately or additionally, the web forms include one or more required information fields requesting information that the end-users 104A, 104B are required to submit to complete the web form.

In some embodiments, after an end-user 104A, 104B has entered end-user data 105A, 105B through a web form hosted by web server 106, the end-user data 105A, 105B is transmitted to the SCARP system 110. Generally, the SCARP system 110 validates the end-user data 105A, 105B and performs one or more actions on the end-user data 105A, 105B.

According to some embodiments, validating the end-user data 105A, 105B includes determining the source web form from which the end-user data 105A, 105B is collected and/or verifying the validity of contact information such as an address, phone number or email address included in the end-user data 105A, 105B.

Determining the source web form from which the end-user data 105A, 105B is collected includes identifying a web form ID embedded in the end-user data 105A, 105B in some examples.

Verifying the validity of an address included in the end-user data 105A, 105B may include checking the address against an online or other database of known addresses. Failure to match the address to any entries in the database may indicate that the address is false.

Verifying the validity of a phone number included in the end-user data 105A, 105B may include checking the format/length of the phone number against a known format/length for a given area. For example, in the United States, phone numbers typically include 10 digits if an area code is included with the phone number. Thus, a phone number that does not include 10 digits may be indicative of an invalid phone number. As used herein, an invalid phone number refers to a phone number that is inoperative to contact the end user 104A, 104B. The definition of invalid phone numbers covers not only phone numbers that lack the necessary digits to function in a given area, but also any other phone number, whether or not it includes a correct number of digits, that is not associated with the end user 104A, 104B.

Accordingly, verifying the validity of a phone number included in the end-user data 105A, 105B alternately or additionally includes comparing the phone number to a list of known invalid phone numbers that are known to be used as fictitious phone numbers by end-users 104A, 104B that do not wish to submit their own phone number. For instance, one invalid phone number that end-users 104A, 104B might submit is the phone number “867-5309” which was popularized by the Tommy Tutone song “867-5309/Jenny.” While the phone number 867-5309 actually works in some area codes in the United States, it is an invalid number to the extent that it is not associated with the end-user 104A, 104B that has submitted it.

Verifying the validity of an email address included in the end-user data 105A, 105B may include checking the format of the email address against a known format. For instance, one known format for email addresses is “username@domain.gTLD,” where gTLD is a generic top level domain such as “com,” “edu,” gov,” “mil,” “net,” “org” or “arpa.” Thus, an email address that does not conform to one or more known email address formats may be indicative of an invalid email address. As used herein, an invalid email address refers to an email address that is inoperative to contact the end user 104A, 104B. The definition of invalid email addresses covers not only email addresses that fail to conform to a particular format, but also any other email address, whether or not it conforms to a particular format, that is not associated with the end user 104A, 104B.

Accordingly, verifying the validity of an email address included in the end-user data 105A, 105B alternately or additionally includes performing a Mail eXchanger (“MX”) lookup and/or contacting a corresponding email server. In particular, the SCARP system 110 may perform an MX lookup by looking up the portion of the email address following the @ sign, e.g., “domain.gTLD,” in the Domain Name System (“DNS”) to identify a corresponding email server accepting email sent to email addresses ending with “domain.gTLD.” Failure to find “domain.gTLD” in the DNS indicates that the email address is invalid.

Even if “domain.gTLD” is found in the DNS, the email address may nevertheless be invalid where “username” does not correspond to an actual email address. Accordingly, after identifying the email server corresponding to “domain.gTLD,” the SCARP system 110 may contact the email server to confirm that “username@domain.gTLD” is an email address serviced by the email server. Alternately or additionally, the SCARP system 110 may delegate the MX lookup and/or contacting the corresponding email server to the web server 106 associated with the entity 108 or to some other server.

Optionally, the extent of validation performed by SCARP system 110 depends on the source web form. For instance, if the web form ID embedded with the end-user data 105A, 105B indicates that the web form is a survey or other web form that does not require any contact information from the end user 104A, 104B or where the validity of the contact information is irrelevant to the use of the end-user data 105A, 105B, the SCARP system 110 may simply determine the web form ID without performing any additional validation. Alternately or additionally, if the web form ID embedded with the end-user data 105A, 105B indicates that the web form is a job application or other web form where it is in the end user's 104A, 104B best interest to provide valid contact information, the SCARP system 110 may determine the web form ID and check the format of the phone number and/or email address without performing any additional validation.

Alternately or additionally, if the web form ID embedded with the end-user data 105A, 105B indicates that the web form is required to be filled out by the end user 104A, 104B to gain access to certain content hosted on the web server 106 such that some end users 104A, 104B (such as those that are interested in engaging the entity 108) are inclined to submit valid contact information and other end users 104A, 104B (such as those that are not ready to engage the entity 108) may be inclined to submit invalid information, the SCARP system 110 may perform substantially all of the validation discussed above. In this manner, the SCARP system 110 separates valid end-user data 105A, 105B from invalid end-user data 105A, 105B such that different actions can be performed on the end-user data 105A, 105B depending on its validity and/or other factors.

After validating the end-user data 105A, 105B, the SCARP system 110 determines one or more actions to perform in relation to the end-user data 105A, 105B. In some examples, the one or more actions include deleting the end-user data 105A, 105B, storing some or all of the end-user data 105A, 105B in a new or pre-existing record associated with the end user 104A, 104B in the CRM system 118, HRIS 20 or other systems, assigning a score to the end-user data 105A, 105B, notifying one or more individuals (such as employees 114) regarding receipt of the end-user data, assigning the end-user data 105A, 105B to one or more individuals (such as employees 114) for follow up, sending a request for an electronic signature to the end user 104A, 104B, sending an email to the end user 104A, 104B, placing an automated telephone call to the end user using a telephone number of the end user, and sending a package to the end user 104A, 104B. Other actions may alternately or additionally be performed by the SCARP system 110. Accordingly, the actions explicitly identified herein should not be construed to limit the invention.

In some embodiments, some or all of the data used in performing the one or more actions in relation to the end-user data 105A, 105B is stored in a database 124. For example, the database 124 may store historic validation data, submission data, a variables dictionary, and/or other data. The historic validation data in some embodiments includes phone number and/or email formats, lists of known invalid phone numbers or email addresses, or the like. The submission data includes some or all of the end-user data 105A, 105B.

### II. SCARP System

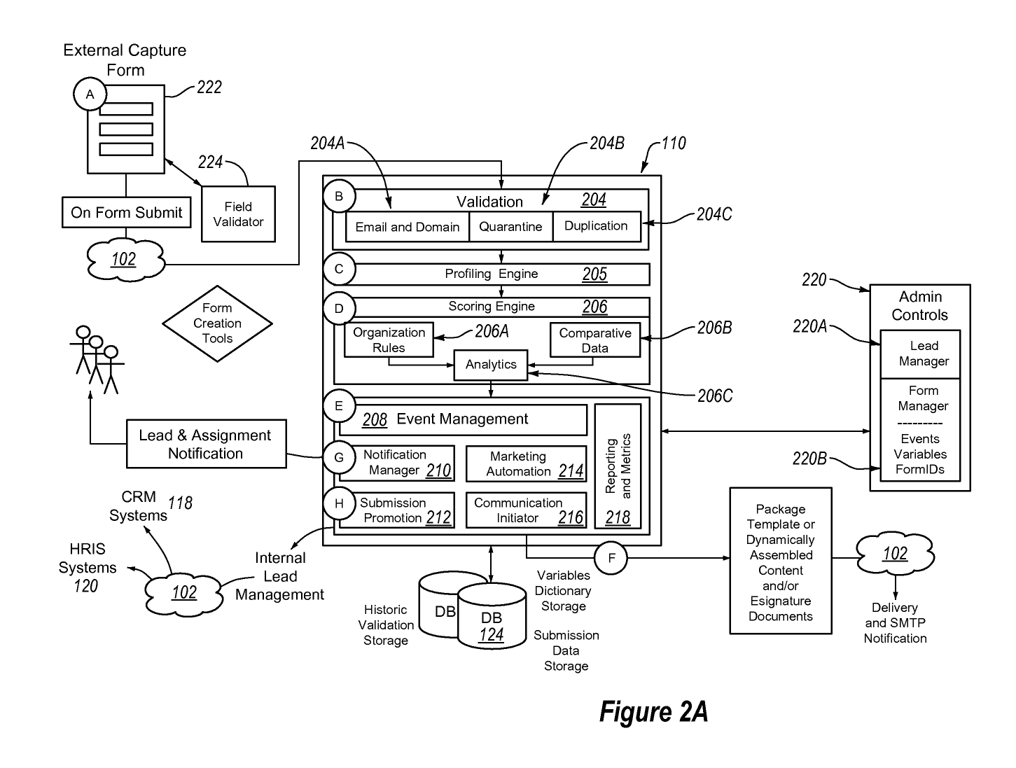

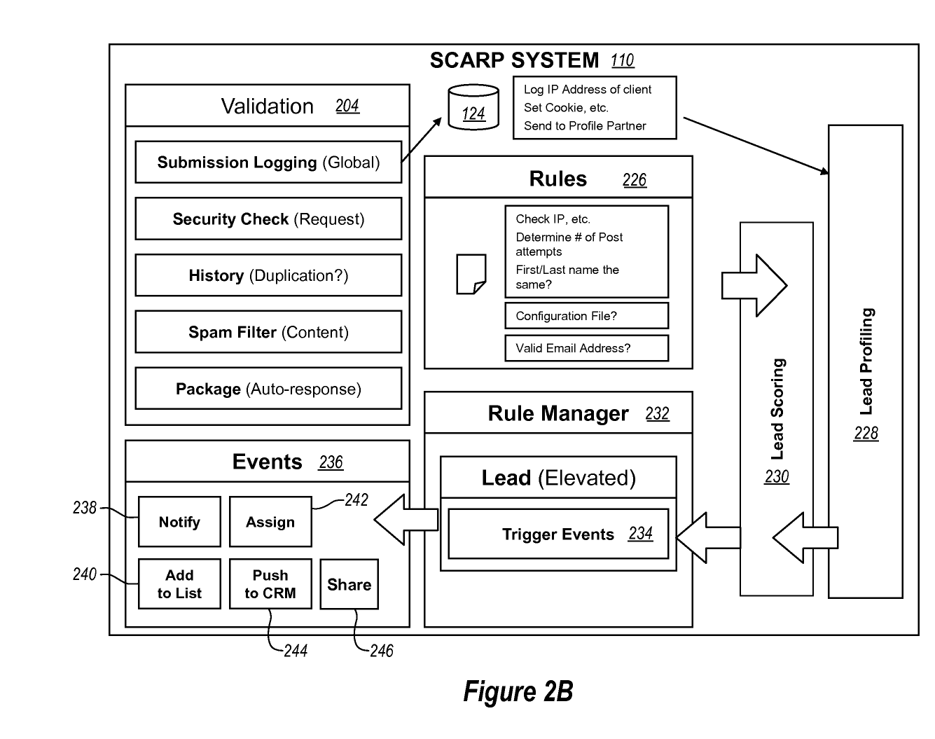

Referring to FIG. 2A, additional details regarding the SCARP system 110 and other aspects of the example network environment 100 of FIG. 1 are disclosed. FIG. 2A further illustrates an example work flow generally denoted by the letters A-H. It will be appreciated that the work flow A-H is only exemplary and the steps corresponding to steps A-H can be rearranged and performed in a different order, some steps can be omitted altogether, and other steps can be added.

As illustrated in FIG. 2A, the SCARP system 110 includes a validation module 204, a profiling engine 205, a scoring engine 206, an event management module 208, a notification manager 210, a submission promotion module 212, a marketing automation module 214, a communication initiator 216 and a reporting and metrics module 218. Optionally, one or more administrative controls 220 operate in conjunction with the SCARP system 110.

The SCARP system 110 communicates over the network 102 with an external capture form 222 that is hosted by, for example, the web server 106 of FIG. 1. The external capture form 222 is an embeddable web form in some examples for collecting end-user data 105A, 105B from end users 104A, 104B. The step of collecting end-user data 105A, 105B is identified by the circled A on the external capture form 202. In some embodiments, the external capture form 222 includes a field validator 224 to perform some of the validation previously discussed above. For example, the field validator 224 may verify that a phone number and/or email address submitted by an end user 104A, 104B conform to a particular format. In some embodiments, the field validator 224 is implemented as a script, such as a JavaScript, running on the external capture form 222.

Alternately or additionally, the external capture form 222 performs certain validations and/or tracks and reports various metrics. For instance, in some embodiments the external capture form 222 performs serverside validation, tracks form attempts and/or form abandonment metrics, performs data repopulation, and/or reports any of the foregoing to the SCARP system 110.

In operation, the external capture form 222 receives end-user data 105A, 105B and provides it to the SCARP system 110. Generally, the validation module 204 receives the end-user data 105A, 105B and performs validation, as represented by the B circled on the validation module 204. In some embodiments, as an initial matter, the validation module 204 identifies an ID of the external capture form 222 used to collect the end-user data 105A, 105B to determine whether any additional validation is to be performed based on the identified ID.

The validation module 204 performs additional validation, if needed, using email and domain validation module 204A, quarantine module 204B and duplication module 204C, which collectively perform some or all of the validation described above with respect to FIG. 1 on the received end-user data 105A, 105B. For instance, the email and domain validation module 204A is configured to verify the format of an email address included in the end-user data 105A, 105B and/or is configured to verify the validity of the email address by performing an MX lookup and/or contacting a corresponding email server. The quarantine module 204B is configured to compare the phone number (and/or email address) included in the end-user data 105A, 105B against a list of known invalid phone numbers (and/or email addresses).

The duplication module 204C is configured to determine whether the end-user data 105A, 105B is duplicative to previously submitted end-user data by comparing certain identifying information in the end-user data 105A, 105B against previously stored end-user data in the database 124. The identifying information included with the end-user data 105A, 105B and checked against the database 124 may include IP addresses, email addresses, phone numbers, cookie data, or the like. Upon identifying duplicate end-user data 105A, 105B, the duplication module 204C determines if the duplicate end-user data 105A, 105B indicates renewed/increased interest on behalf of an end user 104A, 104B and/or a spammer in some examples. Alternately or additionally, the duplication module 204C determines how to handle the duplicate end-user data 105A, 105B to avoid skewing reporting and metrics data and/or whether to trigger certain events, such as sending particular or additional content to the end users 104A, 104B.

In some embodiments, the validation module 204 determines that the end-user data 105A, 105B includes invalid information, such as an invalid phone number, email address, or the like, in which case the validation module 204 deletes the end-user data 105A, 105B without further processing.

After validation at B, the profiling engine 205 is configured to perform profiling of validated end-user data 105A, 105B, as represented by the C circled on the profiling engine 205. Generally, profiling includes performing various lookups on the validated end-user data 105A, 105B to generate a profile for the corresponding end user 104A, 104B. For instance, the profiling engine 205 may perform a reverse lookup of a phone number to identify a corresponding phone book listing associated with the phone number to verify a name and/or address submitted with the end-user data 105A, 105B or to obtain the name and/or address of the end user 104A, 104B. Alternately or additionally, the profiling engine 205 performs an IP lookup on an IP address included with the end-user data 104A, 104B to obtain an indicator of the end user's 104A, 104B geographic location. Alternately or additionally, the profiling engine 205 performs a background check on the end user 104A, 104B using some of the end-user data 105A, 105B. It will be appreciated that the invention is not limited to the specific examples of lookups described herein and includes other types of lookups.

Optionally, after performing the various lookups, the profiling engine 205 generates a profile corresponding to the end user 104A, 104B. Such a profile may include some or all of the end-user data 105A, 105B and/or some or all of the information obtained by performing the lookups. The profiles can then be provided to one or more of the employees 114 for use in following up with end users 104A, 104B.

After profiling at C, the scoring engine 206 performs scoring on some or all of the end-user data 105A, 105B and/or profiles generated by the profiling engine 205, as represented by the D circled on the scoring engine 206. Generally, the scoring engine 206 assigns a score to the end-user data 105A, 105B, which scores can be used to prioritize subsequent handling of the end-user data 105A, 105B, for instance. In the illustrated embodiment, scores are based on organization rules 206A and comparative data 206B which are analyzed at 206C to generate a score. Organization rules 206A include scoring criteria defined by the entity 108 of FIG. 1. Comparative data 206B represents some or all of the data output by the validation module 204 and profiling engine 205 upon performing steps B and C.

Optionally, the scoring engine 206 selectively assigns a score to some end-user data 105A, 105B but not other end-user data 105A, 105B based on the external capture form 222 from which the end-user data 105A, 105B is collected as defined by the organization rules 206A. In this and other examples, an administrator, such as the marketing director 114A or other employee 114, defines particular web forms for which scoring is to be performed in organization rules 206A and the scoring engine 206 assigns scores to end-user data 105A, 105B collected from the particular web forms but not to end-user data 105A, 105B collected from other web forms. Alternately or additionally, the scoring engine 206 selectively assigns a score to end-user data 105A, 105B based on other criteria, or simply assigns a score to all of the end-user data 105A, 105B.

The scores assigned by the scoring engine 206 are based on one or more criteria that may be user-defined, such as organization rules 206A, and/or default criteria. The criteria may include the completeness of the end-user data 105A, 105B, the type of information included in the end-user data 105A, 105B, the content of the end-user data 105A, 105B, or other criteria. For instance, suppose the external capture form 222 is a web form for generating sales leads. An end user 104A that provides a valid address, phone number, and email address with end-user data 105A is probably more ready to purchase products/services from or otherwise engage the entity 108 than an end user 104B that does not provide any contact information at all in the end-user data 105B. Alternately, an end user 104A that provides a valid phone number in end-user data 105A is probably more ready to purchase products/services from or otherwise engage the entity 108 than an end user 104B that does not provide a phone number, but does provide an address with the end-user data 105B. Accordingly, in the first example, the end-user data 105A is assigned a higher score than end-user data 105B because it is more complete than end-user data 105B and in the second example the end-user data 105A is assigned a higher score than end-user data 105B because it includes a phone number.

As another example, the external capture form 222 in some embodiments allows an end user 104A, 104B to select a level of interest, such as whether the end user 104A, 104B is ready to make a purchase from or otherwise engage the entity 108 immediately, within the next 6 months, or within the next year, or that the end user 104A, 104B is merely interested in being added to a mailing list for the entity 108. In this example, end-user data 105A including content that indicates that the end user 104A is ready to make a purchase immediately is assigned a higher score than end-user data 105B including content that indicates that the end user 104B is contemplating making a purchase within the next 6 months or within the next year, or that the end user 104B is merely interested in being added to the mailing list, for instance. The scenarios described herein are provided by way of example only and should not be construed to limit the invention. Indeed, other criteria can alternately or additionally be applied by the scoring engine 206 to assign scores to end-user data 105A, 105B.

After scoring at D, the event management module 208 determines how to handle validated, profiled, and/or scored end-user data 105A, 105B, as represented by the E circled on the event management module 208. In some embodiments, the event management module 208 permits an individual (such as the employees 114) associated with the entity 108 to define one or more triggers and associated actions that automatically occur in response to the triggers. In some embodiments, the actions are communication-based and include sending content to an end user 104A, 104B at step F via communication initiator 216.

The content sent in some examples includes one or more of an email message, a template-based package, a dynamically created package, or one or more electronically signable documents. In this and other examples, the communication initiator 216 is configured to initiate the communication-based action in response to a trigger identified by the event management module 208. The triggers may include criteria that are based on results of the validation module 204, profiling engine 205 and/or scoring engine 206 processing. For instance, if the validation module 204 identifies end-user data 105A as being collected from an external capture form 222 for requesting a job quote and/or if the scoring engine 206 assigns a relatively high score to the end-user data 105A, this combination of results may trigger the communication initiator 220 to automatically send a template-based or dynamically created package to the end user 104A that includes a price list and/or other data.

It will be appreciated that the specific packages sent to the end users 104A, 104B may vary depending on one or more factors including the particular external capture form 202 from which the end-user data 105A, 105B is obtained, a level of interest indicated by the end-user data 105A, 105B, a web page from which the external capture form 202 is accessed by the end users 104A, 104B, or other factors.

The notification manager 210 is configured to generate notifications regarding end-user data 105A, 105B as defined by the administrative controls 220, as represented by the G circled on the notification manager 210. The administrative controls 220 include lead manager controls 220A and form manager controls 220B. The lead manager controls 220A permit an individual, such as the sales manager 114C, to define criteria for automatically notifying one or more individuals regarding reception of end-user data 105A, 105B and/or for assigning the end-user data 105A, 105B to a responsible individual, such as sales representatives 114D-114N, for follow up. The criteria may depend on results of processing performed by one or more of validation module 204, profiling engine 205 or scoring engine 206, for example, or on other criteria.

For instance, the sales manager 114C may specify that a notification is to be sent to the sales manager 114C or one or more of the other employees 114 any time end-user data 105A, 105B is received that is determined to be derived from a particular form indicating that the end-user data 105A, 105B is a sales lead where the end-user data 105A, 105B has been assigned a predetermined minimum score. Alternately or additionally, the sales manager 114C may specify a general rule that end-user data 105A determined to be a general sales lead be assigned on a round-robin rotation or other rotation to sales representatives 114D-114N, while end-user data 105B determined to be a sales lead relating to a particular area of expertise be assigned to a sales representative 114D or 114N having the relevant expertise. More generally, the assignment of end-user data 105A, 105B can be made to particular responsible individuals using any suitable method, or end-user data 105A, 105B can be assigned to an entire group, or randomly to any one of the sales representatives 114D-114N or any one of the sales representatives 114D-114N within a particular group, or the like.

Optionally, assignment of end-user data 105A to a particular sales representative 114D-114N includes sending a notification to the particular sales representative 114D-114N by notification manager 210. In this and other examples, the notification is an SMS text message, email message, or other suitable message. Alternately or additionally, the notification is sent to the particular sales representative 114D-114N through a secure messaging system such as is described in U.S. patent application Ser. No. 11/877,501, entitled “Secure and Intelligent Messaging Architecture,” filed Oct. 23, 2007 (the '501 application), the contents of which is hereby incorporated by reference in its entirety. Alternately or additionally, the notification includes the profile associated with the end-user data 105A, 105B that was generated by the profiling engine 205.

The form manager controls 220B permit an individual that has created an external capture form 222 to define criteria for automatically notifying one or more individuals regarding activity related to the external capture form 222 created by the individual. For instance, the marketing director 114A may create one or more embeddable web forms 216 for generating sales leads and may desire to receive a notification when the external capture form 222 is used. In this example, the marketing director 114A uses the form manager controls 220B to define the criteria for generating the notifications and identifying the individuals to whom the notifications are to be sent.

The submission promotion module 212 is configured to transmit some or all of the end-user data 105A, 105B and/or associated profiles to one or more internal lead management systems and/or external systems, such as the CRM system 118, HRIS 120, or other systems, as represented by the H circled on the submission promotion module 212. In some embodiments, the submission promotion module 212 determines whether to transmit the end-user data 105A, 105B to an external system based on output from one or more of the validation module 204, profiling engine 205 or scoring engine 206 based on criteria that may be user-defined and/or default criteria. For instance, the criteria may establish that end-user data 105A determined by the validation module 204 to have been collected from an external capture form 222 operable to apply for a job opening at the entity 108 is to be transmitted by the submission promotion module 212 to the HRIS 120 where a record for the end user 104A is created and/or updated. As another example, the criteria may establish that end-user data 105B determined by the validation module 204 to have been collected from an external capture form 222 for requesting a quote from the entity 108 is to be transmitted by the submission promotion module 212 to the CRM system 118 where a record for the end user 104B is created and/or updated.

Marketing automation module 214 automatically generates content to send to an end user 104A, 104B based on the output of one or more of validation module 204, profiling engine 205 and/or scoring engine 206.

Reporting and metrics module 218 is generally configured to collect and report metrics from any one or more of a variety of sources. In some embodiments, the external capture form 222 runs a script that generates metrics during the time the end user 104A, 104B is filling out the web form, such as the amount of time taken by the end user 104A, 104B to fill in information fields in the web form, information fields that are left blank by the end user 104A, 104B, a time that the end-user data 105A, 105B is submitted, and/or other metrics. The reporting and metrics module 218 collects and stores these metrics in the database 124 or other suitable location.

When a package is sent to the end user 104A, 104B, the reporting and metrics module 218 is also configured to track how the end user 104A, 104B interacts with the package (“interaction information”). For example, the reporting and metrics module 218 can track which of multiple tabulated pages in the package are viewed by the end user 104A, 104B, the amount of time each tabulated page is viewed, and/or other interaction information. The interaction information is collected by the reporting and metrics module 218 and stored in the database 124 or other suitable location.

Alternately or additionally, the reporting and metrics module 218 tracks end-user data 105A, 105B as it is processed by the SCARP system 110 to keep track of one or more of when the end-user data 105A, 105B is received, when it is validated, when did it get assigned and to whom, what actions were taken in relation to the end-user data 105A, 105B and at what times, or the like.

The reporting and metrics module 218 is also configured to report the metrics, interaction and/or tracking information to one or more individuals (such as employees 114) associated with the entity 108. By providing the metrics, interaction and/or tracking information to the individuals associated with the entity 108, the individuals can adapt or modify the external capture form 222 and/or packages if the metrics and/or interaction information indicate that some or all of the web form 216 or package is not serving an intended purpose, as well as identify bottlenecks in the processing of the end-user data 105A, 105B and/or the performance of individuals to whom the end-user data 105A, 105B is assigned for follow up.

Referring to FIG. 2B, additional details of some aspects of the SCARP system 110 are provided according to some embodiments. The SCARP system 110 of FIG. 2B includes a validation module 204 which may correspond to the validation module 204 of FIG. 2A. In the illustrated embodiment of FIG. 2B, the validation module 204 includes a submission logging module configured to log submissions in the database 124. Logging submissions in the database may include logging an IP address of the client device 112A, 112B, setting a cookie on the client device 112A, 112B, or the like or any combination thereof.

A security check module included in the validation module 204 of FIG. 2B is configured to execute a systematic background check based on the data entered in capture form 222 and the configured type of security check required and internal and external systems accessed.

A history module included in the validation module 204 of FIG. 2B may correspond to the duplication module 204C of FIG. 2A. As such, the history module may be configured to, e.g., determine whether end-user data 105A, 105B is duplicative to previously submitted end-user data by comparing certain identifying information in the end-user data 105A, 105B against previously stored end-user data in the database 124.

Alternately or additionally, the history module may be configured to compare a browser type, IP address, first name, last name, email address, telephone number, geo-location, operating system type, operating system version, cookie information, or other data included in received end-user data 105A, 105B against data previously stored in the database 124. This comparison step may permit the validation module 204 to enhance a pre-existing record corresponding to one of the end users 104A, 104B with any additional information received in the end-user data 105A, 105B, for example.

A spam filter included in the validation module 204 of FIG. 2B may correspond to one or both of the email and domain module 204A and quarantine module 204B of FIG. 2A. As such, the spam filter may be configured to, e.g., verify the format of an email address included in end-user data 105A, 105B, verify the validity of the email address by performing an MX lookup and/or contacting a corresponding email server, comparing a phone number and/or email address included in the end-user data 105A, 105B against a list of known invalid phone numbers and/or email address, or the like or any combination thereof.

A package module included in the validation module 204 of FIG. 2B is configured as an intelligent auto-response of content targeted to the submitter of the capture form 222. This package content can consist of multiple deliveries over a defined time-line, and can be created dynamically based on the data and choices of the submitted Capture form and ultimately reported on.

The SCARP system 110 of FIG. 2B may include various rules or criteria 226 that are applied by one or more of the validation module 204, profiling engine 205, scoring engine 206 or event management module 208 of FIGS. 2A and 2B.

A lead profiling module 228 and a lead scoring module 230 may correspond to the profiling engine 205 and the scoring engine 206, respectively. For example, the lead profiling module 228 may be configured to generate a profile for an end-user 104A, 104B based on end-user data 105A, 105B that identifies the end-user 104A, 104B as a potential lead. Alternately or additionally, the lead scoring module 230 may be configured to perform scoring on some or all of the end-user data 105A, 105B and/or profiles generated by the profiling engine 205 or lead profiling module 228.

A rule manager 232 included in the SCARP system 110 of FIG. 2B may correspond to the event manager 208 of FIG. 2A. As such, the rule manager 232 may be configured to, e.g., determine how to handle validated, profiled, and/or scored end-user data 105A, 105B in response to various trigger events 234.

Various events 236 or actions may be implemented in response to the trigger events 234. The events 236 or actions may include, for example, notify events 238, add-to-list events 240, assign events 242, push-to-CRM events 244, share events 246, or the like or combinations thereof.

Notify events 238 may be implemented by, e.g., the notification manager 210 of FIG. 2A. Implementing a notify event 238 may involve generating and sending a notification regarding end-user data 105A, 105B as defined by administrative controls 220 and explained above.

Implementing an add-to-list event 240 may involve adding validated end-user data 105A, 105B or any entry corresponding to end-user data to a particular existing list or creating a new list such as a CSV (comma delimited) list to be utilized for the purposes of Human Resources mailings, Sales lead lists or emailing Marketing information etc.

Implementing an assign event 242 may involve assigning end-user data 105A, 105B to a particular employee 114 or group of employees 114 of the entity 108.

Push-to-CRM event 244 may be implemented by, e.g., the submission promotion module 212. Implementing a push-to-CRM event 244 may involve transmitting some or all of the end-user data 105A, 105B and/or associated profiles to one or more internal lead management systems and/or external systems, such as the CRM system 118, HRIS 120, or other systems.

Implementing a share event 246 may involve providing the Captured information securely with other appropriate individuals, groups or entities.

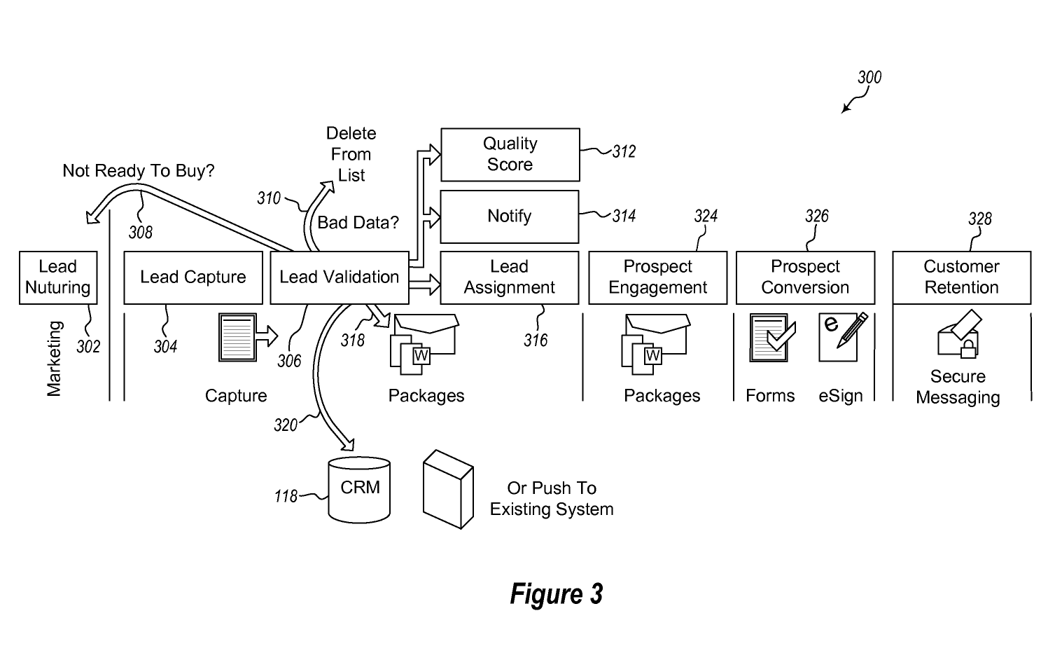

With additional reference to FIG. 3, an example sales cycle 300 is illustrated in which the SCARP system 110 of FIGS. 1-2B can be implemented. The sales cycle 300 of FIG. 3 is described with combined reference to FIGS. 1-3. The sales cycle 300 begins at 302 where sales leads are nurtured by the marketing department 114A. Lead nurturing 302 includes any of a number of activities performed to identify and nurture potential sales leads. Lead nurturing may include the marketing director 114A (or other employees 114 within the marketing department 116A) creating whitepapers, product/service descriptions, or other marketing content, and making the marketing content available to end users 104A, 104B. In some embodiments, the marketing content is sent on a regular basis, such as in a periodic newsletter email, to end users 104A, 104B that have signed up to receive the content, or the content is made available on the external capture form 222 hosted by the web server 106 with access to the content being contingent upon the end users 104A, 104B submitting end-user data 105A, 105B through an external capture form 222, or the like.

The SCARP system 110 captures the end-user data 105A, 105B submitted via external capture form 222 at step 304, validates the end-user data 105A, 105B at step 306, and performs one or more actions in relation to the end-user data 105A, 105B at steps 308, 310, 314, 316, 318, 320 depending on the results of the validation 306. For instance, if the validation step 306 indicates that the end user 104A, 104B is not ready to make a purchase or otherwise engage the entity 108, the end-user data 105A, 105B is provided at step 308 to the marketing department 116A for continued lead nurturing 302. In some embodiments, providing the end-user data 105A, 105B to the marketing department 116A includes adding the end user's 104A, 104B email address included in the end-user data 105A, 105B to a list of end users 104A, 104B that have signed up to receive marketing content and/or adding a record to or updating a preexisting record in an external system for potential leads.

Alternately or additionally, if the validation step 306 indicates that the end user data 105A, 105B includes invalid data (e.g., an invalid phone number, address, email address, etc.) and/or based on other criteria suggesting that the end user 104A, 104B is not interested in receiving marketing content or making a purchase from or otherwise engaging the entity 108, the SCARP system 110 automatically eliminates at step 310 the end-user data 105A, 105B to avoid creating worthless entries in any corresponding systems.

Alternately or additionally, if the validation step 306 indicates that the end user data 105A, 105B includes valid data and/or based on other criteria suggesting that the end user 104A, 104B is interested in making a purchase from or otherwise engaging the entity 108, the SCARP system 110 assigns a score to the end-user data 105A, 105B at step 312, notifies one or more individuals regarding the end-user data 105A, 105B at step 314, assigns the end-user data 105A, 105B as a sales lead to one or more individuals at step 316, generates and sends a package to the end user 104A, 104B at step 318, and/or creates or updates an entry for the end user 104A, 104B in CRM system 118 or other system at step 320.

In some embodiments, the scores assigned during step 312 are used to prioritize the end-user data 105A, 105B such that end-user data 105B received after end-user data 105A may nevertheless be followed up on first by an individual to whom it has been assigned based on the higher score of end-user data 105B as compared to end-user data 105A.

Alternately or additionally, all of the steps 308, 310, 312, 314, 316, 318, 320 are performed automatically by the SCARP system 110, leading to a shortened response time, more efficient management of end-user data 105A, 105B and greater accountability than in sales cycles implemented in some conventional systems.

After lead assignment 316, the sales cycle 300 may further include prospect engagement 322, prospect conversion 324 and/or customer retention 326. Each of steps 322, 324 and 326 can be implemented in whole or in part by the SCARP system 110 and/or the secure messaging system described in the '501 application referenced above. In some embodiments, the SCARP system 110 is implemented as a component of the secure messaging system described in the '501 application.

Accordingly, embodiments of the invention include a flexible SCARP system 110 for managing end-user data 105A, 105B. In particular, after end-user data 105A, 105B is received and validated by the SCARP system 110, any one or more of a variety of actions can be taken in relation to the end-user data 105A, 105B. For example, the end-user data 105A, 105B can be deleted, stored in any one of a plurality of different systems, assigned to one or more individuals, or one or more individuals can be notified of its receipt, a package or other content can be sent to the end user 104A, 104B, and so on.

### III. Packages

Returning to FIG. 1, and as already mentioned above, some embodiments include the ability to automatically generate and/or send an electronic information package (hereinafter “information package”) to an end user 104A, 104B. Information packages can be template-based or dynamically generated. Template-based information packages are created in some embodiments in advance by an employee 114 or other individual associated with the entity 108. Alternately or additionally, template-based information packages are created programmatically. On the other hand, dynamically generated information packages are not created in advance, rather, they are generated on the fly by the package server 111 or SCARP system 110. In some embodiments, each information package relates to a particular product, service, or other topic associated with the entity 108.

In some examples, when the SCARP system 110 receives end-user data 105A, 105B indicating interest in a particular product, service, or topic associated with the entity 108, the SCARP system 110 generates and sends an information package relating to the particular product, service, or topic to the end user 104A, 104B. In the case of a template-based information package, generating the information package may include populating a template-based information package with certain data extracted from the end-user data 105A, 105B. In the case of a dynamically generated information package, generating the information package may include identifying and compiling content related to the particular product service or topic into an information package. Sending the information package to the end-user 104A, 104B may include sending a notification to the end-user 104A, 104B, the notification including a link or links to the contents of the information package. The notification sent to the end user 104A, 104B is an SMTP email notification in some examples.

In some embodiments, the package server 111 is implemented as an application programming interface (“API”) to the secure messaging system described in the '501 application. According to this and other examples, when an individual such as an employee 114 desires to send an information package to an end user 104A, 104B, the individual creates an XML or other file that includes an email address of end user 104A, 104B, the subject of the notification to be sent to the end user 104A, 104B, a message to include in the notification, and the content to include in the information package, and then calls the API with the XML file.

When the API receives the XML file, in some examples the API authenticates the sender (e.g., employee 114 of entity 108) by checking for a token, username and/or password accompanying the XML file. Further, the API can save the XML file in the database 1214 as a new information package template. Alternately or additionally, the XML created by the employee 114 and received by the API may simply include instructions to send a pre-existing template-based information package.

Generally, information packages implement one or more multi-faceted messaging features as described in U.S. patent application Ser. No. 12/059,289, entitled “Multi-Faceted, Dynamic Messaging,” filed Mar. 31, 2008 (the '289 application), the contents of which is hereby incorporated by reference in its entirety. Multi-faceted messaging features include layout instructions, such as multi-dimensional formatting which displays content sections in tabulated pages (tabulations can include related and unrelated content). Layout features of multi-faceted messaging also include in-package rendering of attachments, sidebar display of content, displaying content sections as modals on a page in different locations and/or sizes. Multi-faceted messaging features also include functional features such as embedded applications and interstitial communications (focused or isolated message viewing). Further, multi-faceted messaging features include proxying features such as advertising, single sign-on features, as well as protected URLs. Some embodiments are thus directed to systems and methods for creating, storing, sending, receiving, displaying and archiving multi-faceted information. These unique and novel methods allow organizations and individual users to send complex sets of information and present that information in logical and convenient ways not possible with current technology.

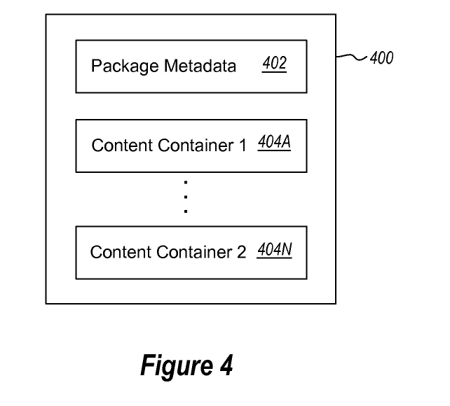

FIG. 4 depicts a conceptual diagram of an example electronic information package 400 (hereinafter “information package 400”) that is created with and stored by package server 111 on database 124. The information package 400 includes package metadata 402. The package metadata 402 is a file that contains information about the information package 400 that can be used to determine access functionality as well as rendering functionality. The access and rendering functionality is defined in some embodiments by the creator of the information package 400. Alternately or additionally, the access and rendering functionality is defined automatically by the package server 111. When analyzed at the package server 111, the package metadata 402 can determine a timing for accessing the information package 400, a number of permitted accesses of the information package 400, whether the information package 400 can be accessed by multiple end users 104, and the like. Alternately or additionally, when analyzed at the package server 111, the package metadata 402 can determine how the information package 400 should be rendered to the end user 104A, 104B, whether files associated with content included in the content sections can be downloaded, and the like.

The information package 400 also includes any number of content containers 404A to 404N. As used herein, the term “content container” generally refers to a data structure configured to hold content. Examples of content in a content container 404A, 404N includes textual content and “content files,” such as, but not limited to, documents, videos, images, vcards, URLs, audio files, and the like. The package metadata 402 in some embodiments includes information specific to a given content container 404A, 404N. For instance, the package metadata 402 may specify whether a content container 404A that is an audio file can be downloaded separate from the information package 400.

Alternately or additionally, the content containers 404A, 404N include pointers to content files that may be hosted by the web server 106 and/or stored in the database 124 of FIG. 1. In this and other embodiments, the creator of an information package 400 has a significant degree of control over the content of the information package 400 even after the information package 400 has been sent to an end user 104A, 104B. In particular, the creator of the information package 400 or other individual associated with entity 108 can modify the actual content files hosted by the web server 106 and/or stored in the database 124. Because the content containers 404A, 404N include pointers to content files, rather than the content files themselves, anytime an end user 104A, 104B accesses an information package 400 after the content files have been updated or modified, the pointers within the content containers 404A, 404N will direct the end user 104A, 104B to the updated or modified content, rather than the original content.

In some embodiments, the package server 111 implements a package wizard for creating information packages 400. For example, an individual creating an information package 400 can be guided step-by-step to define access functionality for the information package 400, as well as the content to include in the information package 400 and the rendering functionality for the different content. The package wizard may also permit the individual creating the information package 400 to specify one or more template fields for population with data extracted from end-user data 105A, 105B. The triggers for sending the information package 400 to an end user 104A, 104B can be defined through the package wizard or through the event management module 208 of the SCARP system 110.

Information packages 400 are saved by the package server 111 on the database 124. In some embodiments, saving an information package 400 on the database 124 includes saving the package metadata 402 and content containers 404A, 404N on the database 124. As already mentioned, the content containers 404A, 404N in some embodiments merely include pointers to the actual content of the information package 400. By using pointers, the actual content can be stored in virtually any network accessible location, such as on the database 124, web server 106, Internet, or other location.

An information package 400 may be sent to an end user 104A, 104B by sending a notification to the end user 104A, 104B regarding the availability of the information package 400. In some embodiments, the notification is an SMTP message including an embedded link to the information package 400 on the database 124, requests for the link being serviced by the package server 111. To access the information package 400, the end user 104A, 104B selects the link to request the information package 400 and the information package 400 is displayed in a browser or other suitable application.

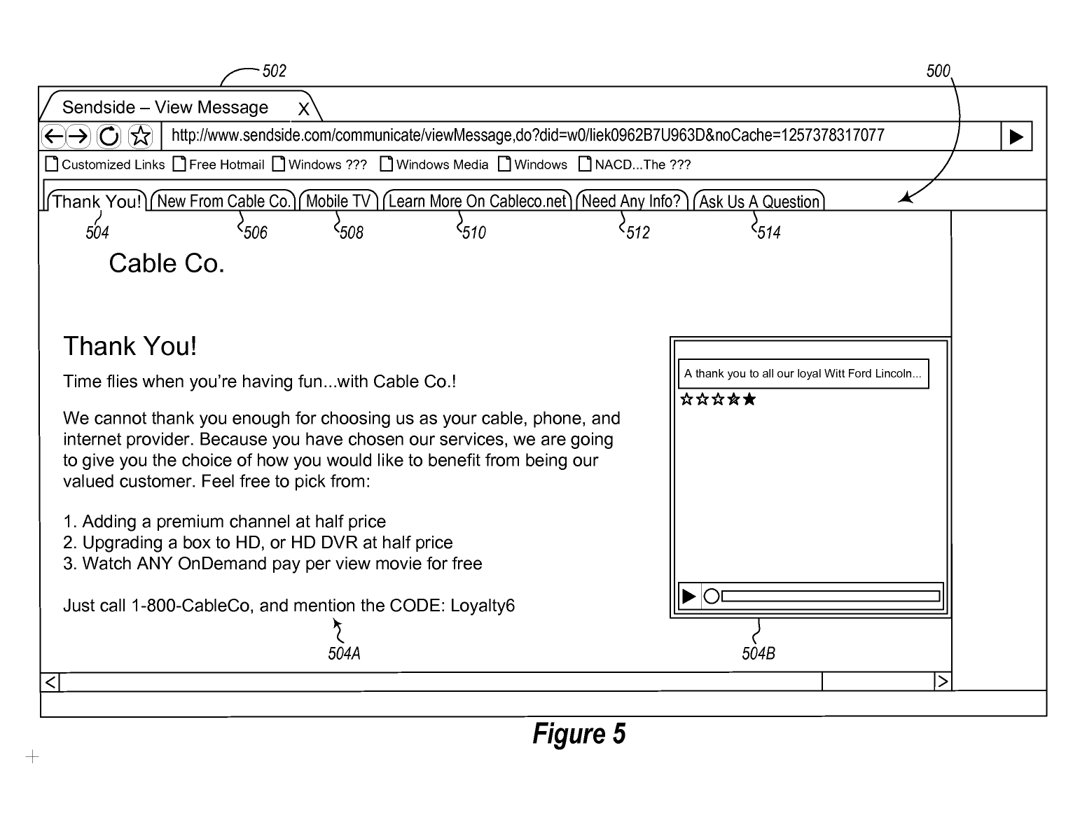

FIG. 5 depicts an example of an electronic information package 500 (hereinafter “information package 500”) displayed in a browser 502, the information package 500 relating to new customers of an example company named “Cable Co.”. The information package 500 displayed in the browser 502 of FIG. 5 corresponds to the information package 400 conceptually illustrated in FIG. 4 in some embodiments. As illustrated in FIG. 5, the information package 500 includes a plurality of tabulations 504, 506, 508, 510, 512, 514, each depicting different content. For example, the first tabulation includes textual content 504A and video content 504B. When selected, the remaining tabulations 506, 508, 510, 512, 514 depict HTML content, some or all of which is hosted on web server 106.

In this and other embodiments, the information package 500 is accessed through the package server 111. Because of this, the package server 111 can track how an end user 104A, 104B interacts with the information package 500. For instance, in some embodiments, the package server 111 implements cookies or scripts to track whether the end user 104A, 104B interacts with the different tabulations 504, 506, 508, 510, 512, 514, and if so, the amount of time spent viewing each tabulation 504, 506, 508, 510, 512, 514, or other metrics regarding interaction. Alternately or additionally, the package server 111 tracks whether the end user 104A, 104B interacts with certain elements within each tabulation 504, 506, 508, 510, 512, 514. In the example of FIG. 5, this may include tracking whether the end user 104A, 104B interacts with the video 504B of the first tabulation 504 by, for example, viewing all or a portion of the video 504B.

The embodiments described herein may include the use of a special purpose or general-purpose computer including various computer hardware or software modules, as discussed in greater detail below.

Embodiments within the scope of the present invention also include transitory and non-transitory computer-readable media for carrying or having computer-executable instructions or data structures stored thereon. Such computer-readable media can be any available media that can be accessed by a general purpose or special purpose computer. By way of example, and not limitation, non-transitory computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of capturing end-user data, comprising:
receiving end-user data;
validating the end-user data;
assigning a score to at least some of the end-user data based on the validation; and
performing at least one of a plurality of different actions in relation to the end-user data based on the assigned score.

2. The method of claim 1, wherein the plurality of different actions include:
automatically creating a list including a plurality of names identifying a plurality of end users, the list further including a plurality of email addresses corresponding to the plurality of end users, the plurality of names and the plurality of email addresses having been received in a plurality of submissions including end-user data;
providing the end-user data to a marketing department of an entity;
deleting the end-user data;
notifying one or more individuals regarding receipt of the end-user data;
automatically placing a telephone call to a telephone number included in the end-user data, the telephone number being associated with an end user;
automatically sending an electronic (email) message to an email address included in the end-user data, the email address being associated with the end user;
automatically sending an electronic information package to the email address;
automatically storing the end-user data in a customer resource management system or customer relationship management system; and
automatically opening up a connection and sharing some or all of the end-user data with one or more individuals, groups or entities.

3. The method of claim 1, further comprising:
receiving a plurality of submissions including end-user data corresponding to a plurality of end users;
logging all of the submissions in a database including creating a separate record for each end user; and
comparing new end-user data corresponding to a first end user and received in a new submission against end-user data logged in the database to determine previous submission activity by email, name or company, or IP address.

4. The method of claim 3, wherein each of the end user records includes at least one of:
a browser type of a corresponding browser through which a corresponding submission of end-user data was made;
an IP address of a corresponding client device used to access an online web form to make a submission of end-user data;
a first or last name of a corresponding end user that made a submission of end-user data;
an email address of a corresponding end user that made a submission of end-user data;
a telephone number of a corresponding end user that made a submission of end-user data;
a geo-location of a corresponding client device used to access an online web form to make a submission of end-user data;
an operating system type of a corresponding operating system executed on a corresponding client device used to access an online web form to make a submission of end-user data;
an operating system version of a corresponding operating system executed on a corresponding client device used to access an online web form to make a submission of end-user data; or
cookie information corresponding to a cookie executed on a corresponding client device used to access an online web form to make a submission of end-user data.

5. The method of claim 1, further comprising determining an origin or path of an end user in reaching an online web form used to submit the end-user data.

6. The method of claim 1, wherein performing at least one of the plurality of different actions in relation to the end-user data is further based on at least one of: an email address included in the end-user data, a company identified in the end-user data, a first or last name included in the end-user data, or a particular product or service identified in the end-user data.

7. The method of claim 1, wherein the assigned score is further based on events that are triggered by an end user who submitted the end-user data or by events that are triggered by a recipient of the end-user data.

8. The method of claim 1, further comprising generating a profile of an end user based on the received end-user data.

9. The method of claim 8, wherein generating a profile of the end user based on the received end-user data includes collecting information regarding the end user from one or more online sources.

10. The method of claim 9, wherein collecting information regarding the end user includes at least one of:
performing a reverse lookup of a telephone number included in the end-user data to obtain a name, an address, or both a name and an address, of the end user;
performing an IP lookup on an IP address included in the end-user data to identify an approximate geographic location of the end user;
performing a background check on the end user using at least some of the end-user data.

11. The method of claim 8, further comprising forwarding the profile to a sales representative for use in following up with the end user regarding a product or service inquiry submitted by the end user with the end-user data.

12. The method of claim 1, wherein an online web form used to submit the end-user data includes a field for receiving contact information and further wherein validating the end-user data includes verifying whether the contact information is valid.

13. The method of claim 12, further comprising determining that the contact information is invalid, wherein performing at least one of a plurality of different actions in relation to the end-user data includes deleting the end-user data.

14. The method of claim 12, wherein the contact information includes a mailing address and further wherein verifying whether the contact information is valid includes checking the mailing address against an online database of known mailing addresses.

15. The method of claim 12, wherein the contact information includes a telephone number and further wherein verifying whether the contact information is valid includes determining whether a format or length of the telephone number matches a known format or length of telephone numbers for a given geographic area.

16. The method of claim 15, wherein verifying whether the contact information is valid further includes determining whether the telephone number matches any telephone numbers included in a list of known fictitious telephone numbers.

17. The method of claim 12, wherein the contact information includes an email address and further wherein verifying whether the contact information is valid includes determining whether a format of the email address matches a known email address format.

18. The method of claim 17, wherein verifying whether the contact information is valid further includes performing a Mail eXchanger lookup on the email address to identify whether an email server purportedly identified by the email address exists, and if such an email server is identified, contacting the email server to confirm whether the email address is serviced by the email server.

19. A non-transitory computer-readable medium including instructions that are executable by a computer to perform operations comprising:
receiving end-user data;
validating the end-user data;
assigning a score to at least some of the end-user data based on the validation; and
performing at least one of a plurality of different actions in relation to the w end-user data based on the assigned score.

20. The non-transitory computer-readable medium of claim 19, wherein the instructions are executable by a computer to perform further operations comprising:
logging submissions from a plurality of end users in a database, each submission including end-user data corresponding to a different end user;
comparing new end-user data received from a first end user in a new submission against end-user data logged in the database to determine whether a record corresponding to the first end user already exists in the database;
determining an origin or path of an end user in reaching an online web form used to submit the end-user data;
automatically placing a telephone call to a telephone number included in the end-user data, the telephone number being associated with an end user;
automatically sending an electronic (email) message to an email address included in the end-user data, the email address being associated with the end user;
automatically sending an electronic information package to the email address;
automatically creating a list including a plurality of names identifying a plurality of end users, the list further including a plurality of email addresses corresponding to the plurality of end users, the plurality of names and the plurality of email addresses having been received in a plurality of submissions including end-user data; and
automatically storing the end-user data in a customer resource management system or customer relationship management system;
wherein performing at least one of a plurality of different actions in relation to the end-user data is further based on at least one of: the assigned score, an email address included in the end-user data, a company identified in the end-user data, a first or last name included in the end-user data, or a particular product or service identified in the end-user data; and
wherein the assigned score is further based on events that are triggered by an end user who submitted the end-user data or by events that are triggered by a recipient of the end-user data.
